(19) United States
(12) Patent Application Publication
(10) Pub. No.: US 2013/0193083 A1
(43) Pub. Date: Aug. 1, 2013

(54) FILTRATION SYSTEM

(71) Applicants: Nathaniel Royce Kamp, Peoria, IL (US); Jeffrey Robert Ries, Metamora, IL (US)

(72) Inventors: Nathaniel Royce Kamp, Peoria, IL (US); Jeffrey Robert Ries, Metamora, IL (US)

(21) Appl. No.: 13/362,782

(22) Filed: Jan. 31, 2012

(51) Int. Cl. B01D 29/00; B01D 37/00; B01D 35/28

(52) U.S. Cl. 210/767; 210/443; 210/444; 210/440

(57) ABSTRACT

A filtration system includes a housing having an inlet, an outlet, a first chamber fluidly connected to the inlet, a second chamber fluidly connected to the outlet, and a wall separating the first and second chambers. The system also includes a removable filter assembly, at least a portion of the filter assembly being disposed within the first chamber of the housing. The system further includes a lid removably connected to the housing. The lid includes a passage fluidly connecting the first and second chambers.

### TECHNICAL FIELD

The present disclosure relates to filtration systems and, more particularly, to filtration systems configured to filter fluids.

### BACKGROUND

Many systems filter fluids to remove contaminants from the fluid. For example, fuel systems, lubrication systems, and/or hydraulic systems employed by a variety of machines often include one or more filter assemblies that remove contaminants from fluids used by these systems. Typically, such filter assemblies are removably disposed within a top-load filter housing, and the uncleaned fluid enters the housing through a passage in an outer wall of the housing. The fluid then passes through a filter media of the filter assembly where contaminants entrained within the fluid are trapped. The filter media used in filter assemblies of this type is typically cylindrical, and after passing through the filter media, the cleaned fluid is directed into an open central channel of the filter media. From this central channel, the cleaned fluid passes into a rigid standpipe connected to the housing. For example, the cleaned fluid may enter the standpipe through an open upper end of the standpipe, or through one or more openings in the side of the standpipe. The cleaned fluid then passes to an outlet of the housing through an open bottom end of the standpipe.

For example, U.S. Pat. No. 7,527,739 to Jiang et al. (“the '739 patent”) discloses a fuel-water separator with first and second filter media disposed in a top-load filter housing. The first filter media sits outside of the second filter media, and the housing includes a standpipe extending through respective central channels of the first and second filter media. As explained in the '739 patent, fuel may flow radially inward through the first and second filter media, and may then be directed into the standpipe prior to exiting the housing.

While the first and second filter media taught in the '739 patent may be capable of removing contaminants from various fluids, top-load housings of the type disclosed in the '739 patent have a variety of drawbacks. For example, due to the configuration of such housings, unfiltered fluid may be passed to machine components downstream of the housing if the housing has not been completely drained prior to removing the filter media. For example, if uncleaned fluid resides on the standpipe after reinstalling the filter media, this uncleaned fluid will be passed to the outlet of the housing, without being filtered, upon startup of the machine to which the housing is connected. In addition, if the filter media is reinstalled before the housing has been completely drained, some volume of residual uncleaned fluid may be trapped proximate the base of the standpipe within the open central channel of the reinstalled filter media. This residual uncleaned fluid will also be passed to the outlet of the housing, without being filtered, upon startup. The passage of such unfiltered fluid may, over time, hinder the performance of the machine and/or its various components.

The exemplary embodiments of the present disclosure are intended to overcome the deficiencies described above.

### SUMMARY

In an exemplary embodiment of the present disclosure, a filtration system includes a housing having an inlet, an outlet, a first chamber fluidly connected to the inlet, a second chamber fluidly connected to the outlet, and a wall separating the first and second chambers. The system also includes a removable filter assembly, at least a portion of the filter assembly being disposed within the first chamber of the housing. The system further includes a lid removably connected to the housing. The lid includes a passage fluidly connecting the first and second chambers.

In another exemplary embodiment of the present disclosure, a filtration system includes a housing having a first chamber, a second chamber, and an opening at a top of the housing providing access to at least one of the first and second chambers. The housing includes an inlet fluidly connected to the first chamber and an outlet fluidly connected to the second chamber. The system also includes a lid removably connected to the top of the housing above the opening. The system further includes a filter assembly. The filter assembly includes filter media having a first end, a second end, and a central passage extending from the first end to the second end. The filter media is disposed within the first chamber and is removable from the first chamber via the opening. The lid fluidly connects the central passage to the second chamber.

In a further exemplary embodiment of the present disclosure, a method of filtering a fluid includes passing the fluid into a first chamber of a housing, and directing the fluid through a filter media disposed within the first chamber to a central passage of the filter media. The method also includes directing the fluid from the central passage to a second chamber of the housing via a passage in a lid. The lid is removably attached to a top of the housing and extends over the first and second chambers.

### BRIEF DESCRIPTION OF THE DRAWINGS

FIG. 1 illustrates a filter assembly according to an exemplary embodiment of the present disclosure.

FIG. 2 illustrates a top plate of the filter assembly shown in FIG. 1.

FIG. 3 illustrates a lid according to an exemplary embodiment of the present disclosure.

FIG. 4 illustrates a partial cross-section of a filtration system according to an exemplary embodiment of the present disclosure.

FIG. 5 illustrates a filter assembly according to another exemplary embodiment of the present disclosure.

FIG. 6 illustrates a top plate of the filter assembly shown in FIG. 5.

FIG. 7 illustrates a partial cross-section of a filtration system according to another exemplary embodiment of the present disclosure.

FIG. 8 illustrates a filter assembly according to a further exemplary embodiment of the present disclosure.

FIG. 9 illustrates a lid according to still another exemplary embodiment of the present disclosure.

FIG. 10 illustrates a housing according to an exemplary embodiment of the present disclosure.

FIG. 11 illustrates a partial cross-section of a filtration system according to another exemplary embodiment of the present disclosure.

### DETAILED DESCRIPTION

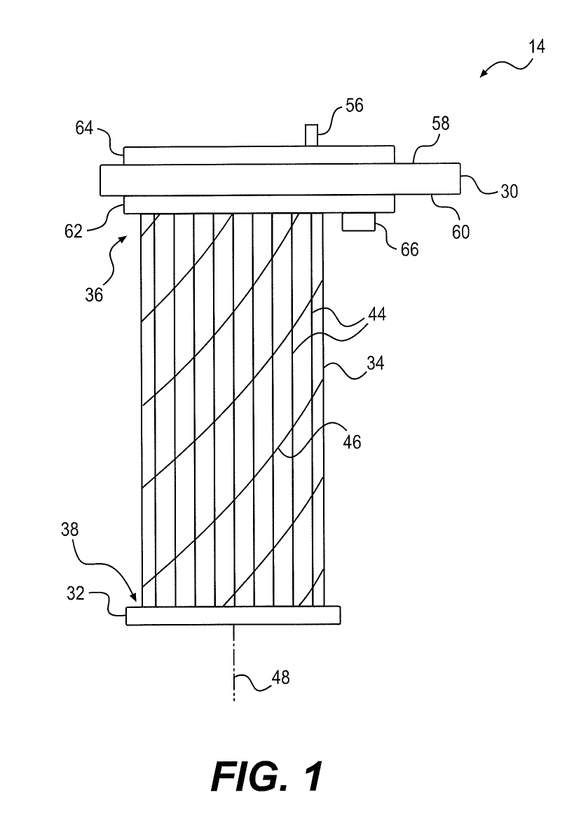

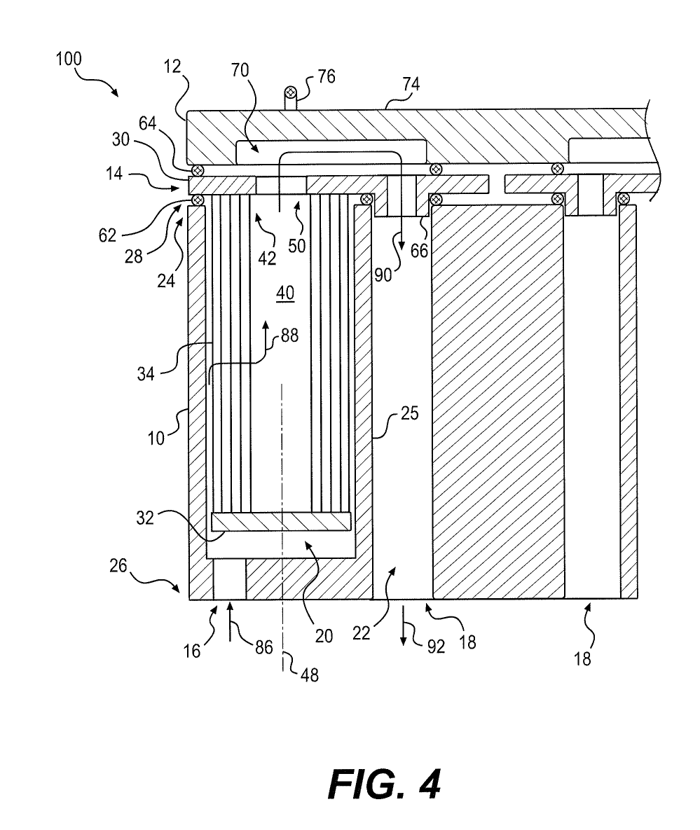

FIGS. 1-4 illustrate various components of a filtration system 100 according to an exemplary embodiment of the present disclosure. As will be described with respect to FIGS. 4, 7, and 11, each of the exemplary filtration systems 100, 200, 300 disclosed herein may include at least one of a housing 10, a lid 12, and a filter assembly 14. Although the respective housing 10, lid 12, and filter assembly 14 of the exemplary filtration systems 100, 200, 300 may have various configurations, like item numbers will be used throughout this disclosure to identify like parts.

As shown in FIG. 4, an exemplary housing 10 may include at least one inlet 16 and at least one outlet 18. Although the inlet 16 and outlet 18 are shown as being disposed at a bottom 26 of the housing 10, in additional exemplary embodiments, at least one of the inlet 16 and outlet 18 may be disposed at a different location on the housing 10, such as on a sidewall of the housing 10. The inlet 16 and/or the outlet 18 may comprise a passage, channel, thru hole, port, and/or other like structure facilitating the passage of fluid into and/or out of the housing 10. For example, the inlet 16 may be configured for connection to a source of pressurized fluid. In exemplary embodiments, the inlet 16 and/or the outlet 18 may further include one or more valves, fittings, flanges, couplings, and/or other like devices configured to assist in connecting the housing 10 to a source of pressurized fluid and/or to a machine component requiring filtered fluid.

The housing 10 may also include one or more chambers fluidly connected to the inlet 16 and the outlet 18. For example, the housing 10 may include a first chamber 20 fluidly connected to the inlet 16, and a second chamber 20 fluidly connected to the outlet 18. The chambers 20, 22 may have any shape, size, and/or other configuration to assist in accepting one or more components of the filtration system 100, 200, 300. For example, at least one of the chambers 20, 22 may be substantially cylindrical, and may have any length, diameter, and/or other configuration to facilitate insertion of at least a portion of the filter assembly 14 therein and/or removal of the portion of the filter assembly 14 therefrom. The chambers 20, 22 may also be configured to assist in directing fluid through the housing 10. For example, the chamber 20 may assist in directing pressurized and/or unfiltered fluid entering the chamber 20 through the inlet 16, through a portion of the filter assembly 14 disposed within the chamber 20. As will be described in greater detail below, such fluid may eventually be directed to the chamber 22, and the chamber 22 may assist in directing the fluid to the outlet 18.

As shown in FIG. 4, in an exemplary embodiment, the housing 10 may also include a wall 25 separating the first and second chambers 20, 22. In exemplary embodiments, the housing 10 may be made from metals, alloys, cast iron, plastics, polymers, and/or other like materials. In such exemplary embodiments, the housing 10 may be formed through any known machining, molding, extrusion, casting, or other like process. During such manufacturing processes, the chambers 20, 22, wall 25, inlet 16, outlet 18, and/or other features of the housing 10 may be formed to have any desirable configuration. In exemplary embodiments, a top 24 of the housing 10 may include one or more openings 28. For example, as shown in FIG. 4, an opening 28 at the top 24 of the housing 10 may provide access to one or more of the chambers 20, 22 and/or to portions of the filter assembly 14 disposed therein. In an exemplary embodiment, a first opening 28 may be an opening at a top of the chamber 20, and a second opening 28 may be an opening at a top of the chamber 22. In such exemplary embodiments, the portion of the filter assembly 14 disposed within the chamber 20 may be removable from the chamber 20 and/or the housing 10 via the opening 28.

The filter assembly 14 may be any of type of filtration device including, but not limited to, a fuel filter, an oil filter, or a hydraulic filter. In exemplary embodiments, the filter assembly 14 may include a top plate 30, an end cap 32, and a filter media 34. As shown in at least FIG. 1, the filter media 34 may have a first end 36 sealed to the top plate 30 and a second end 38 sealed to the end cap 32. The filter media 34 may have any shape, size, and/or other configuration known in the art. In exemplary embodiments, the filter media 34 may be substantially cylindrical, and may include a central passage 40 (FIG. 4). The central passage 40 may be sealed at and/or otherwise blocked by the end cap 32, and may have an outlet 42 that is fluidly connected to and/or otherwise accessible through an opening 50 in the top plate 30. The filter media 34 may also include a longitudinal axis 48 extending centrally therethrough. For example, the longitudinal axis 48 may extend through the center of the central passage 40.

The filter media 34 may include any material or materials configured to filter fluid. In some embodiments, filter media 34 may include cellulose material, spun polyester, or any other material suitable for filtering purposes. The filter media 34 may include a single layer of filter material, such as cellulose filter material. Alternatively, the filter media 34 may include multiple layers of filter material integrally constructed. For example, the filter media 34 may include a base of cellulose material with a coating of melt-blown polyester. In some embodiments, the filter media 34 may be a sheet of material folded into longitudinal pleats 44 (i.e., pleats whose folds extend parallel to longitudinal axis 48), as shown in FIG. 1.

In additional exemplary embodiments, the filter assembly 14 may include a reinforcing member 46. The reinforcing member 46 may be disposed radially outward of the filter media 34. The reinforcing member 46 may include any structure or structures that extend around the filter media 34 and provide support thereto without blocking fluid flow through filter media 34. The reinforcing member 46 may include various types of structural members that leave openings for fluid to flow through. In some embodiments, the reinforcing member 46 may include one or more cords or wires wrapped circumferentially around the filter media 34 at axial intervals. For example, the reinforcing member 46 may comprise fiber roving wrapped helically around the filter media 34. The reinforcing member 46 may be secured to the filter media 34 in various ways. In some embodiments, the reinforcing member 46 may be adhered or tied to the filter media 34. In alternative exemplary embodiments, the reinforcing member 46 may be woven into and/or formed integrally with the filter media 34.

In exemplary embodiments, the filter assembly 14 and/or the filter media 34 may include a hollow center tube (not shown) extending from the first end 36 of the filter media 34 to the second end 38. In exemplary embodiments, the center tube may be positioned within the filter media 34 such that the longitudinal axis 48 extends centrally therethrough. Such an exemplary center tube may comprise a cylindrical wall extending around the longitudinal axis 48 and defining the open central passage 40 of the filter media 34 along the longitudinal axis 48. For example, the center tube may have a substantially circular cross-section centered around the longitudinal axis 48, and the center tube may assist in defining the outlet 42 of the central passage 40. Additionally, in some exemplary embodiments, the center tube may have a configuration that allows fluid to flow radially (relative to longitudinal axis 48) through the center tube. For example, the center tube may include openings along the length thereof to permit fluid to flow into the center tube and/or the central passage 40 as the fluid passes through the filter media 34 in a direction toward the longitudinal axis 48. Such exemplary center tubes may be made from plastics, polymers, metals, alloys, and/or other like materials. In some embodiments, the filter media 34 may be formed around, adhered to, and/or otherwise coupled to the center tube. In additional exemplary embodiments, the center tube may be adhered to, formed integrally with, and/or otherwise connected to the top plate 30 and/or the end cap 32. Alternatively, in further exemplary embodiments, the center tube may be omitted, and the central passage 40 may be formed by the filter media 34.

The filter media 34 may be secured to the top plate 30 and/or the end cap 32 in various ways. In some embodiments, the filter media 34 may be secured to the top plate 30 and to the end cap 32 by embedding the respective ends 36, 38 of the filter media 34 within the top plate 30 and end cap 32. For example, a bottom surface 60 of the top plate 30 may be heated to a molten state, and the first end 36 of the filter media 34 may be inserted into the molten material and held there until the bottom surface 60 solidifies with the filter media 34 embedded therein. The second end 38 of the filter media 34 may be secured to the end cap 32 in a similar manner. Alternatively, the filter media 34 may be adhered to and/or otherwise connected to the top plate 30 and/or the end cap 32.

The exemplary top plates 30 and end caps 32 of the present disclosure may have various configurations. For example, the various end caps 32 of the present disclosure may be substantially planar, substantially disc-shaped pieces of material configured to plug, block, and/or otherwise seal the second end 38 of the filter media 34. For example, the filter media 34 may be sealed to the end cap 32 such that fluid disposed within and/or passing through the filter media 34, the center tube (not shown), and/or the central passage 40 may be prohibited from exiting the filter assembly 14 through the second end 38. In particular, in such exemplary embodiments the central passage 40 and the second end 38 of the filter media 34 may be sealed at the end cap 32 such that fluid within the central passage 40 may only exit the central passage 40 through the outlet 42 opposite the end cap 32. The end cap 32 may also block pressurized fluid entering the first chamber 20 of the housing 10 via the inlet 16 from entering the central passage 40 via the second end 38. Instead, such fluid may be directed to enter the central passage 40 by passing through the filter media 34.

As shown in at least FIG. 1, the top plate 30 may include a top surface 58 opposite the bottom surface 60, and a handle 56 may be connected to and/or otherwise disposed on the top surface 58. The top plate 30 may have any shape, size, and/or other configuration desired for supporting the filter media 34. For example, the filter media 34 may be inserted within the first chamber 20, removed from the chamber 20, and/or otherwise maneuvered relative to the housing 10 by manipulating the top plate 30 and/or the handle 56. The top plate 30 may be formed from any of the materials described above with respect to the end cap 32, and may be manufactured through similar processes.

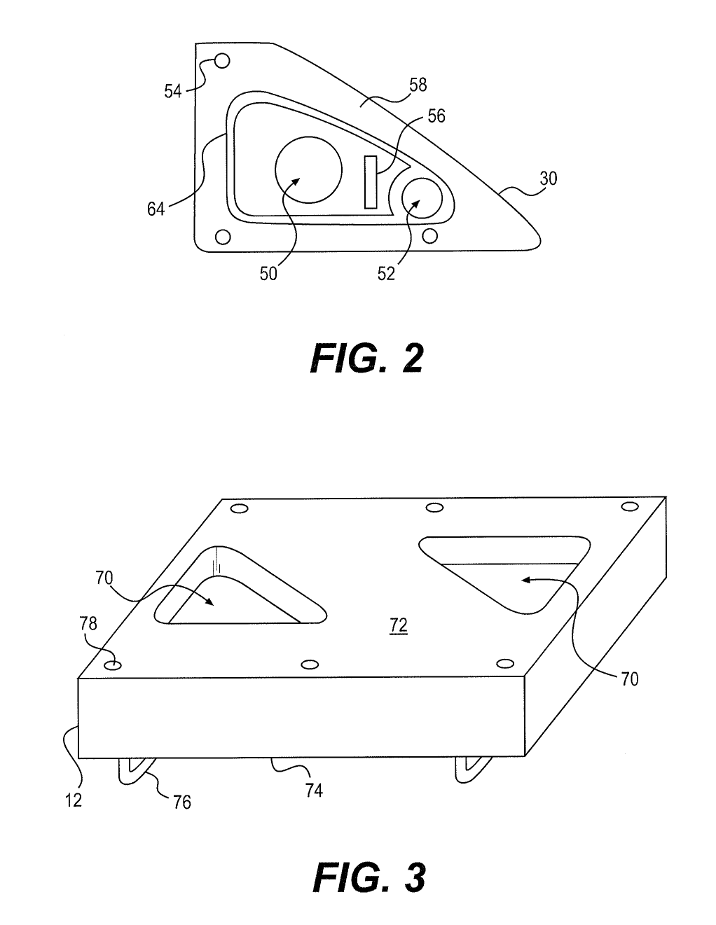

As shown in at least FIGS. 2 and 4, the top plate 30 may be substantially planar and may include one or more openings 50, 52. Such openings 50, 52 may be thru holes extending from the top surface 58 to the bottom surface 60. In exemplary embodiments, a first opening 50 may be substantially aligned with the central passage 40 of the filter media 34 and a second opening 52 may be substantially aligned with a port 66 extending from the top plate 30 adjacent the filter media 34. For example, the opening 50 may be fluidly connected to the central passage 40 such that fluid exiting the central passage 40 through the outlet 42 may be directed through the opening 50. In this way, the outlet 42 of the central passage 42 may be accessible through the opening 50 in the top plate 30.

The opening 52 may be fluidly connected to the port 66, and the opening 52 may assist in directing fluid through the top plate 30 and into the second chamber 22 via the port 66. The port 66 may assist in aligning, for example, the top plate 30 and/or other components of the filter assembly 14 with the housing 10 as a portion of the filter assembly 14 is inserted into the housing 10. For example, the port 66 may assist in aligning the top plate 30 with the first and second chambers 20, 22 as the filter media 34 is inserted into the first chamber 20. Such alignment may occur, for example, by inserting the port 66 into the second chamber 22 and simultaneously inserting the filter media 34 into the first chamber 20. In such exemplary embodiments, the port 66 may extend from the opening 52 into the second chamber 22. The port 66 may be formed integrally with the top plate 30 or, alternatively, the port 66 may be adhered, molded, welded, soldered, fused, and/or otherwise connected to the top plate 30. The port 66 may extend substantially perpendicularly from the bottom surface 60.

The top plate 30 may further include one or more thru holes 54 configured to assist in bolting and/or otherwise connecting the top plate 30 to, for example, the housing 10. The top plate 30 may also include at least one gasket, O-ring, and/or other like structure configured to form a fluid-tight seal between the top plate 30 and an adjoining component of the filtration system 100, 200, 300. Such structures will be referred to generically as “seal(s),” for the duration of this disclosure, for ease of description. Such seals may be adhered, overmolded, fitted, pressed, and/or otherwise connected to the top plate 30 by any known means. For example, in the embodiment illustrated in FIGS. 1, 2, and 4, the filtration system 100 may include a top plate 30 having first and second seals 62, 64. The seal 62 may be disposed on the bottom surface 60 of the top plate 30, and may extend around the filter media 34. In particular, at least a portion of the seal 62 may be disposed adjacent to the filter media 34, and may extend around and/or otherwise encircle the first end 36 of the filter media 34. In exemplary embodiments, the seal 62 may seal the filter assembly 14 to the housing 10. For example, the seal 62 may seal the top plate 30 to the housing 10 when the filter media 34 is disposed within the chamber 20. In addition, as shown in FIGS. 1, 2, and 4, the seal 64 may extend around at least one of the openings 50, 52 in the top plate 30. In exemplary embodiments, the seal 64 may be disposed on the top surface 58 of the top plate 30, and may seal the lid 12 to the filter assembly 14 during use. In particular, the seal 64 may seal the top plate 30 to the lid 12 when the lid 12 is connected to the housing 10.

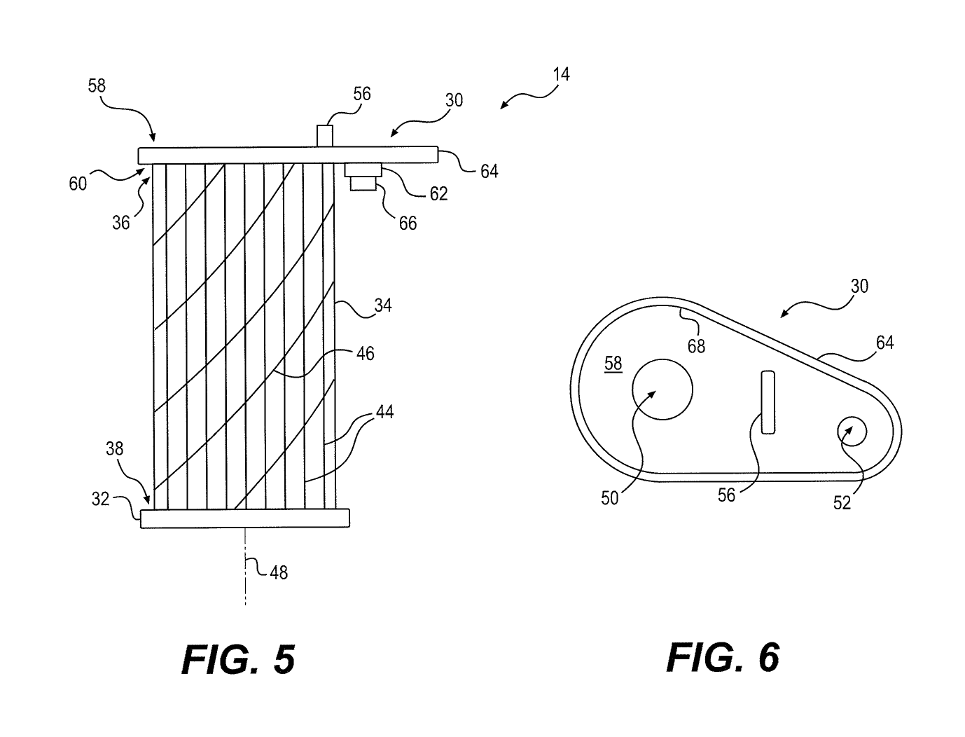

FIGS. 5, 6, and 7 illustrate an additional exemplary embodiment in which the seal 62 is disposed on the bottom surface 60 of the top plate 30 adjacent the filter media 34, and in which the seal 64 extends around the openings 50, 52. However, in the exemplary embodiment of FIGS. 5, 6, and 7, the seal 62 comprises a substantially annular seal disposed proximate and/or adjacent an outer circumference of the port 66. The seal 62 extends around the port 66 and seals the top plate 30 to the chamber 22 and/or other portions of the housing 10 during use. Additionally, the seal 64 extends around a perimeter 68 of the top plate 30 and seals the top plate 30 to both the housing 10 and the lid 12. In such exemplary embodiments, the perimeter 68 of the top plate 30 may include one or more grooves, cut-outs, or other like structures to assist in retaining the seal 64 at the perimeter 68. As shown in FIG. 6, in such embodiments the top plate 30 may have a substantially rounded, substantially elliptical shape, and such a shape may differ from the shape of the exemplary top plate 30 shown in FIG. 1.

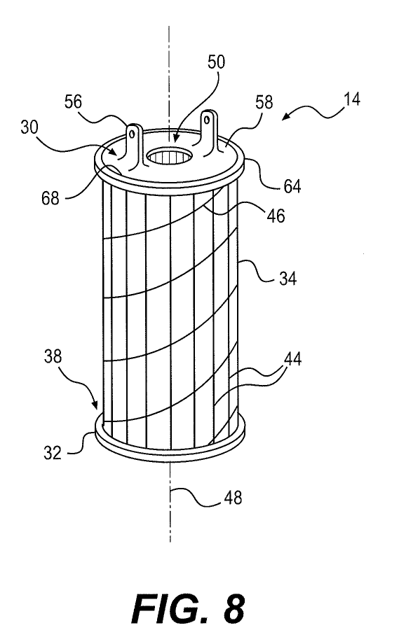

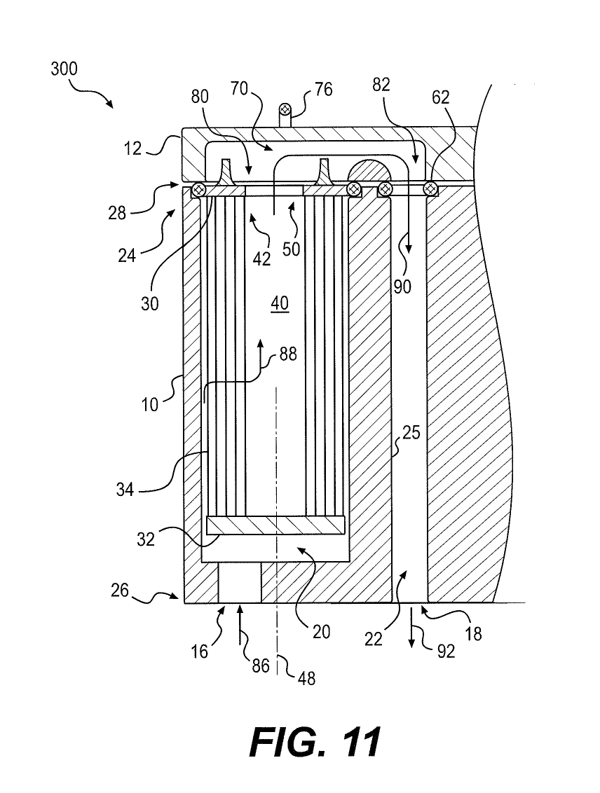

FIGS. 8 and 11 illustrate yet another exemplary embodiment in which the top plate 30 is substantially disc-shaped and includes a single opening 50. In such an exemplary embodiment, the seal 64 may extend around the perimeter 68 of the top plate 30 as described above with respect to FIGS. 5, 6, and 7, and the seal 64 may seal the top plate 30 to both the housing 10 and the lid 12 during use. In addition, as shown in FIG. 10, the housing 10 may include a recess 84 at one or more of the openings 28. For example, a first recess 84 may be formed at the opening 28 associated with the chamber 20, and a second recess 84 may be formed at the opening 28 associated with the chamber 22. In such an exemplary embodiment, at least a portion of the seal 64 and/or the top plate 30 may be disposed within the recess 84 formed at the opening 28 of the chamber 22 when the filter media 34 is disposed within the chamber 20. Likewise, at least a portion of the seal 62 may be disposed within the recess 84 formed at the opening 28 of the chamber 22 during use.

With continued reference to the exemplary embodiments of FIGS. 1-7, the lid 12 may comprise any substantially rigid structure configured to assist in securing the filter assembly 14 relative to the housing 10 while assisting in directing fluid from the first chamber 20 of the housing 10 to the second chamber 20. The lid 12 may be formed from any of the materials described above with respect to the housing 10. In exemplary embodiments, the lid 12 may be a substantially square or substantially rectangular block configured to be mounted to the housing 10 and/or to be connected with the top plate 30 of the filter assembly 14. For example, the lid 12 may include one or more thru holes 78 to assist in bolting and/or otherwise connecting the lid 12 to the housing 10, and the thru holes 78 of the lid 12 may align with and/or otherwise correspond to, for example, the thru holes 54 of the exemplary top plate 30 shown in FIG. 2. The lid 12 may include a bottom surface 72, and a top surface 74 opposite the bottom surface 72. In exemplary embodiments, the lid 12 may also include one or more handles 76 disposed on the top surface 74. Alternatively, at least one of the handles 76 may be disposed on a side surface of the lid 12. Such handles 76 may assist in positioning the lid 12 on the top 24 of the housing 10 while connecting the lid 12 to the housing. Such handles 76 may also assist in disconnecting and/or removing the lid 12 from the housing 10 such that the filter assembly 14 can be removed via the top 24 of the housing 10.

The bottom surface 72 may be substantially planar and, in exemplary embodiments, the bottom surface 72 may be machined to within a desired tolerance. Such machining may assist in forming a substantially flat, substantially uniform bottom surface 72, and such a surface 72 may assist in forming a substantially fluid-tight seal between, for example, the bottom surface 72 and the various components of the filtration system 100, 200, 300. Such a substantially fluid-tight seal may be formed by one or more of the seals 62, 64 mating with the bottom surface 72 during use. For example, the seals 64 may seal the lid 12 to the filter assembly 14 above the first and second chambers 20, 22. In such exemplary embodiments, the lid 12 may extend over the first and second chambers 20, 22 at the top 24 of the housing 10. It is understood that in additional exemplary embodiments, the bottom surface 72 may mate with at least a portion of the housing 10 and/or the filter assembly 14 to form such a fluid-tight seal. Any of the seals 62, 64 described above, and/or an additional seal may assist in forming such a seal between the bottom surface 72, and the housing 10 and/or the filter assembly 14.

As shown in at least FIGS. 3, 4, and 7, an exemplary embodiment of the lid 12 may include at least one passage 70 fluidly connecting the first and second chambers 20, 22. In an exemplary embodiment, the passage 70 may be a recess formed in the bottom surface 72. Such a passage 70 may be formed through, for example, any molding or casting process. Alternatively, such a passage 70 may be formed by removing material from the bottom surface 72 through any machining process until a desired shape, size, location, and/or other configuration of the passage 70 has been obtained. Such an exemplary passage 70 may extend, for example, from the first chamber 20 to the second chamber 22, and from the first opening 50 of the top plate 30 to the second opening 52. Thus, the passage 70 may be fluidly connected to the outlet 42 of the central passage 40 via the first opening 50 in the top plate 30. The passage 70 may also be fluidly connected to the second chamber 22 via the second opening 52 and/or the port 66. It is understood that the various configurations of the passage 70 may be tailored to correspond with, for example, the shape, size, and/or other configurations of the exemplary top plate 30 being employed. It is also understood that the fluid connections described above between the passage 70 and the various components of the housing 10 and/or the filter assembly 14 may be facilitated by the one or more seals 62, 64 described above.

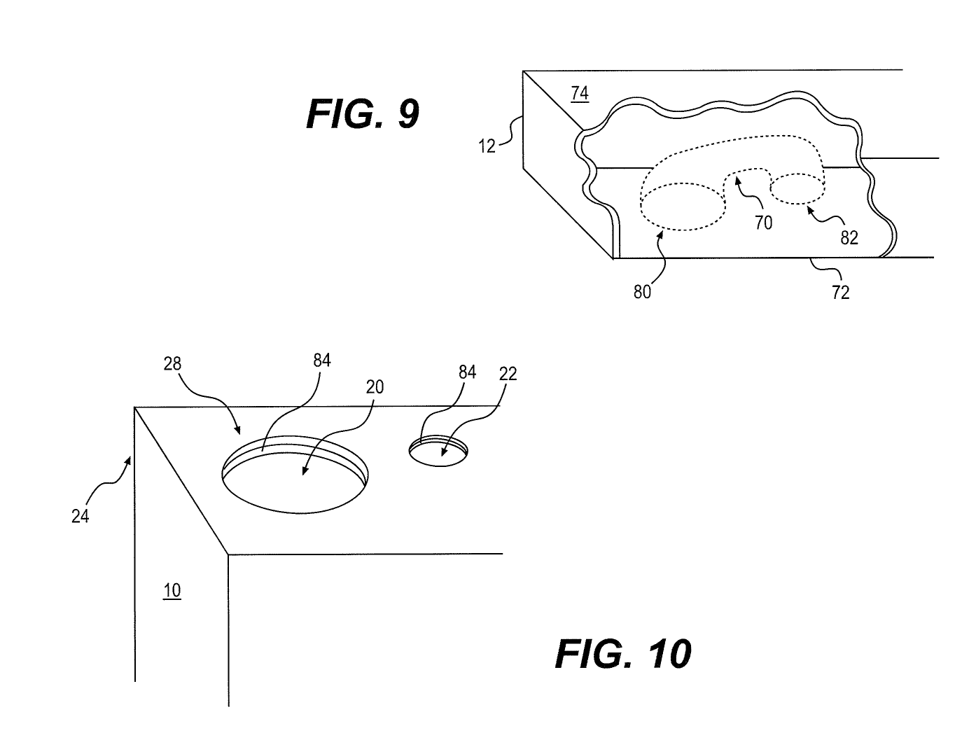

As shown in at least FIGS. 9 and 11, an additional exemplary embodiment of the lid 12 may include at least one passage 70 fluidly connecting the first and second chambers 20, 22, and in such an exemplary embodiment, the passage 70 may be a channel formed internal to the lid 12. Such an internal passage 70 is shown in phantom in the cut-away view of FIG. 9. Such an exemplary passage 70 may include both an inlet 80 and an outlet 82 on the bottom surface 72. The inlet 80 of such a passage 70 may be separate from the outlet 82 on the bottom surface 72. Such a passage 70 may be formed through, for example, any casting process known in the art.

The various components of the filtration systems 100, 200, 300 are not limited to the exemplary embodiments described above. For example, one or more additional clamps, brackets, seals, recesses, flanges, and/or other like structures may be used to hold the filter assembly 14 and/or the lid 12 in position relative to the housing 10. Such additional components may also assist in fluidly sealing the various components of the filtration systems 100, 200, 300 to one another. Furthermore, in additional exemplary embodiments, the housing 10 may include one or more additional filter assemblies 14 disposed therein. At least a portion of such additional filter assemblies 14 may be disposed within, for example, additional respective chambers of the housing 10, and such additional chambers may be similar to the chamber 20 described above. In such exemplary embodiments, the additional filter assemblies 14 may be fluidly separate from one another or, alternatively, the multiple filter assemblies 14 may be fluidly connected in series or in parallel. The housing 10 and/or the lid 12 may facilitate such fluid connection between the filter assemblies 14 via any of the passages, channels, or other structures described above.

### INDUSTRIAL APPLICABILITY

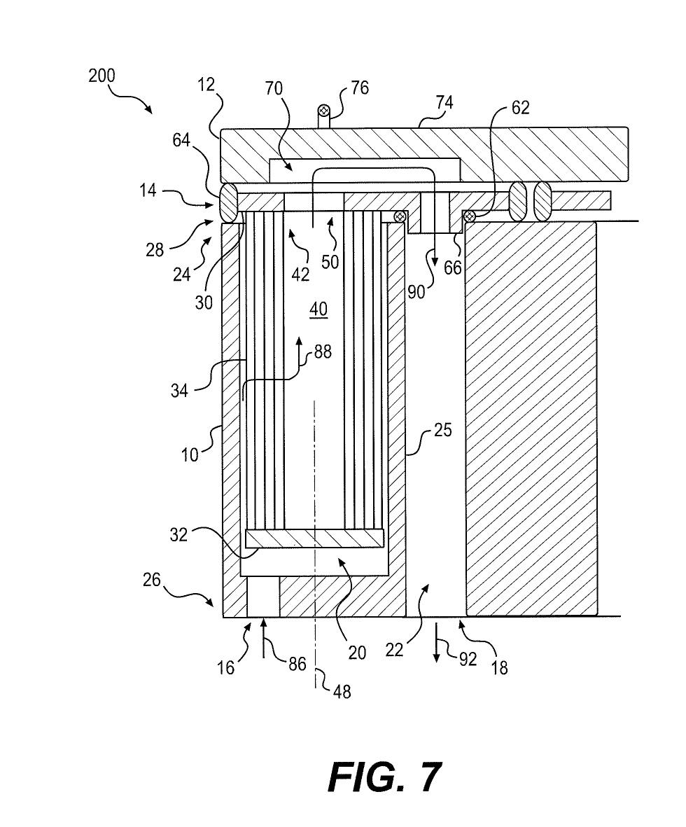

The filtration systems 100, 200, 300 of the present disclosure may be used in any application or environment requiring the filtering of fluid. For example, such systems 100, 200, 300 may be fluidly connected to lubrication, fuel, oil, hydraulic, steering, brake, and/or other like fluid systems of known machines to remove contaminants from the various fluids used in such systems. Such machines may include, for example, any mining, construction, farming, and/or transportation machine known in the art. For example, such machines may include on-highway or off-highway machines, vehicles, or the like. As shown in FIGS. 4 and 7, the lid 12 and housing 10 of systems 100 and 200 may be substantially similar, however, the configuration and/or location of the seals 62, 64, as well as the configuration of the top plate 30, used in these exemplary systems 100, 200 may differ. Further, as shown in FIG. 11, in additional exemplary embodiments of the filtration system 300, the lid 12 may include an internal passage 70, the top plate 30 may be substantially disc-shaped, and the seals 62, 64 may be configured to seat at least partially within the recess 84 of the housing 10.

During use, fluid may enter the housing 10 via the inlet 16 in the direction of arrow 86 (FIGS. 4, 7, and 11). Such fluid may be provided to the housing 10 by, for example, a pump, a tank, a pressurized rail, and/or other like sources of pressurized fluid. Such sources may be disposed on and/or otherwise carried by the machine to which the housing 10 is connected. Upon entering the housing 10, the fluid may pass into the first chamber 20, and may flow around the closed end cap 32. The end cap 32 may block the fluid from entering the filter media 34 at the second end 38. Instead, the fluid may be directed through the filter media 34 disposed within the chamber 20 in the direction of arrow 88. For example, the fluid may pass substantially orthogonal and/or substantially transverse to the filter media 34 in a direction toward the longitudinal axis 48. Based on variations in the flow of such fluid through the filter media 34, it is understood that such fluid may flow through the filter media 34 to the central passage 40 at any angle relative to the longitudinal axis 48. As the fluid passes through the filter media 34, contaminants entrained in the fluid may be removed from the fluid by the filter media 34.

The cleaned and/or otherwise filtered fluid within the central passage 40 may flow vertically upward toward the outlet 42 of the central passage 40. For example, the fluid may be directed by the central passage 40 toward the top 24 of the housing 10. As illustrated by arrow 90, the fluid may be directed from the central passage 40 to the chamber 22 of the housing 10 via the passage 70 of the lid 12. For example, the fluid may be directed from the central passage 40 to the passage 70 via the first opening 50 in the top plate 30. At least one of the seals 62, 64 may assist in retaining such fluid within the filtration system 100, 200, 300 as it exits through the outlet 42. For example, such seals 62, 64 may prohibit the fluid from escaping through the one or more openings 28 at the top 24 of the housing 10 as the fluid passes from the central passage 40 to the passage 70 of the lid 12.

The fluid may be directed from the passage 70 of the lid 12 to the chamber 22 via the second opening 52 in the top plate 30 and/or via the port 66 extending from the top plate 30. At least one of the seals 62, 64 may assist in retaining such fluid within the filtration system 100, 200, 300 as it exits through the passage 70. For example, such seals 62, 64 may prohibit the fluid from escaping through the one or more openings 28 at the top 24 of the housing 10 as the fluid passes from the passage 70 of the lid 12 to the chamber 22. Upon entering the chamber 22, the filtered fluid may be directed vertically downward away from the top 24 of the housing 10, and the fluid may exit the housing 10 via the outlet 18 in the direction of arrow 92.

The disclosed embodiments may provide a number of advantages over known filtration systems. For example, it is common for known filtration systems to direct residual unfiltered fluid from the housing to downstream components when the filter assembly is removed for servicing and/or replacement. However, because the first end 36 of the filter media 34 of the present disclosure is sealed to the top plate 30 and the second end 38 is sealed to the end cap 32, unfiltered fluid disposed within the chamber 20 may only enter the center passage 40 by passing through the filter media 34. This flow of unfiltered fluid may also be facilitated by at least one of the seals 62, 64 and/or the end cap 32 blocking the central passage 40 at the second end 38 of the filter media 34. Accordingly, due to the configuration of the housing 10, the lid 12, and the filter assembly 14, unfiltered fluid may be prohibited from exiting the housing 10 via the outlet 22 after the filter assembly 14 has been reinstalled. Instead, the unfiltered fluid is forced to pass through the filter media 34 upon start up of the machine and/or before exiting the housing 10. Since the filtration systems 100, 200, 300 of the present disclosure prohibit unfiltered fluid from passing to downstream components of the machine, the reliability and functionality of such components may be improved.

It will be apparent to those skilled in the art that various modifications and variations can be made in the disclosed systems and methods without departing from the scope of the disclosure. Other embodiments of the disclosed systems and methods will be apparent to those skilled in the art from consideration of the specification and practice of the systems and methods disclosed herein. It is intended that the specification and examples be considered as exemplary only, with a true scope of the disclosure being indicated by the following claims and their equivalents.

What is claimed is:

1. A filtration system, comprising:
a housing including an inlet, an outlet, a first chamber fluidly connected to the inlet, a second chamber fluidly connected to the outlet, and a wall separating the first and second chambers;
a removable filter assembly, at least a portion of the filter assembly being disposed within the first chamber of the housing; and
a lid removably connected to the housing, the lid including a passage fluidly connecting the first and second chambers.

2. The system of claim 1, wherein the lid is sealed to the filter assembly and extends over the first and second chambers at a top of the housing, the filter assembly being removable via the top of the housing when the lid is disconnected.

3. The system of claim 1, wherein the lid includes a surface mating with at least one of the filter assembly and the housing, and wherein the passage comprises a recess formed in the surface.

4. The system of claim 1, wherein the lid includes a surface mating with at least one of the filter assembly and the housing, and wherein the passage comprises a channel formed internal to the lid, the passage having a separate inlet and outlet on the surface.

5. The system of claim 1, wherein the filter assembly includes a top plate, an end cap, and a filter media having a first end sealed to the top plate and a second end sealed to the end cap.

6. The system of claim 5, wherein the filter media is substantially cylindrical and includes a central passage, the central passage being blocked by the end cap at the second end and having an outlet fluidly connected to an opening in the top plate.

7. The system of claim 5, wherein the top plate includes a port extending from the top plate adjacent the filter media.

8. The system of claim 7, further including a first seal disposed on a bottom surface of the top plate, the first seal extending around the port and sealing the top plate to the second chamber.

9. The system of claim 8, further including a second seal extending around a perimeter of the top plate, the second seal sealing the top plate to both the housing and the lid.

10. The system of claim 5, further including first and second seals,
the first seal being disposed on a bottom surface of the top plate and extending around the filter media, the first seal sealing the top plate to the housing,
the second seal being disposed on a top surface of the top plate and extending around a pair of openings in the top plate, the second seal sealing the top plate to the lid.

11. A filtration system, comprising:
a housing including a first chamber, a second chamber, and an opening at a top of the housing providing access to at least one of the first and second chambers, the housing having an inlet fluidly connected to the first chamber and an outlet fluidly connected to the second chamber;
a lid removably connected to the top of the housing above the opening; and
a filter assembly including a filter media having a first end, a second end, and a central passage extending from the first end to the second end, the filter media being disposed within the first chamber and being removable from the first chamber via the opening, wherein the lid fluidly connects the central passage to the second chamber.

12. The filtration system of claim 11, wherein the inlet of the housing is configured for connection to a source of pressurized fluid, and wherein pressurized fluid entering the first chamber through the inlet is directed to the central passage by passing through the filter media.

13. The filtration system of claim 11, wherein the filter assembly includes a top plate sealed to the first end of the filter media and an end cap sealed to the second end of the filter media, the central passage being blocked by the end cap at the second end of the filter media and having an outlet fluidly connected to a first opening in the top plate.

14. The filtration system of claim 13, wherein the lid includes a passage, the passage being fluidly connected to the outlet of the central passage via the first opening in the top plate, and being fluidly connected to the second chamber via a second opening in the top plate.

15. The filtration system of claim 14, wherein the top plate further includes a port extending from the second opening into the second chamber.

16. The filtration system of claim 13, further including a first seal sealing the filter assembly to the housing and a second seal sealing the lid to the filter assembly.

17. The filtration system of claim 16, wherein the first seal is disposed on a bottom surface of the top plate adjacent the filter media, and the second seal extends around the first opening in the top plate.

18. A method of filtering a fluid, comprising:
passing the fluid into a first chamber of a housing;
directing the fluid through a filter media disposed within the first chamber to a central passage of the filter media; and
directing the fluid from the central passage to a second chamber of the housing via a passage in a lid, the lid being removably attached to a top of the housing and extending over the first and second chambers.

19. The method of claim 18, further including directing the fluid from the central passage of the filter media to the passage of the lid via a first opening in a top plate sealed to the filter media.

20. The method of claim 19, further including directing the fluid from the passage of the lid to the second chamber via a second opening in the top plate.
